(19) United States
(12) Patent Application Publication
(10) Pub. No.: US 2011/0075162 A1
(43) Pub. Date: Mar. 31, 2011

(54) EXPOSURE AVERAGING

(76) Inventors: John J. Saettel, Trotwood, OH (US); Rodney G. Mader, Springfield, OH (US)

(21) Appl. No.: 12/568,762

(22) Filed: Sep. 29, 2009

(51) Int. Cl. G06F 15/00

(52) U.S. Cl. 358/1.9

(57) ABSTRACT

A method for capturing an image in a multi-color printing system, the method includes the steps of providing a test pattern on a print media having a plurality of test patterns aligned in a first direction in a repeating pattern; providing an image capture device having a shutter that controls a time interval during which a single image is captured; and flashing a strobe light multiple times within the time interval in which a single image is captured; wherein each strobe light flash is synchronized with motion of the test pattern past the image capture device so that each test pattern is illuminated by a single strobe-light flash at substantially the same location within the captured image.

### CROSS REFERENCE TO RELATED APPLICATIONS

Reference is made to commonly assigned U.S. patent application Ser. No. ______ (Docket 95645) filed Sep. 29, 2009 by John Saettel, entitled “Color To Color Registration Target”, commonly assigned U.S. patent application Ser. No. ______ (Docket 94958) filed Sep. 29, 2009 by John Saettel, entitled “A Calibration System for Multi-Printhead Ink Systems”, and commonly assigned U.S. patent application Ser. No. ______ (Docket 95644) filed Sep. 29, 2009 by John Saettel, entitled “Automated Time of Flight Speed Compensation”, the disclosures of which are herein incorporated by reference.

### FIELD OF THE INVENTION

The present invention generally relates to high-speed, multi-color printing systems in which test marks are imaged for calibration and the like and, more particularly to, capturing multiple lines of a test pattern in one image capture by flashing the strobe when each line of the test pattern passes the same location while holding the camera exposure open during the entire image capture time period.

### BACKGROUND OF THE INVENTION

High-speed, multi-color printing systems print test patterns that are subsequently captured for use in calibration and the like. U.S. Pat. No. 4,794,453 discloses one such high-speed printing system that prints and captures test patterns. In this disclosure, a test pattern is created by printheads, and a camera and strobe are synchronized so that a test pattern is captured. In order to minimize interference, the strobe is discharged a predetermined time before image capture. To capture multiple lines of a test pattern, the above-described image capture process must be repeated for each line of the test pattern.

Although the above-described method is satisfactory, improvements are always desired. One such improvement is to capture multiple lines in a single image capture.

### SUMMARY OF THE INVENTION

The present invention is directed to overcoming one or more of the problems set forth above. Briefly summarized, according to one aspect of the invention, the invention resides in a method for capturing an image in a multi-color printing system, the method comprising the steps of providing a test pattern on a print media having a plurality of test patterns aligned in a first direction in a repeating pattern; providing an image capture device having a shutter that controls a time interval during which a single image is captured; and flashing a strobe light multiple times within the time interval in which a single image is captured; wherein each strobe light flash is synchronized with motion of the test pattern past the image capture device so that each test pattern is illuminated by a single strobe-light flash at substantially the same location within the captured image.

It is an object of the present invention to capture multiple test pattern lines in a single image capture.

These and other objects, features, and advantages of the present invention will become apparent to those skilled in the art upon a reading of the following detailed description when taken in conjunction with the drawings wherein there is shown and described an illustrative embodiment of the invention.

### ADVANTAGEOUS EFFECT OF THE INVENTION

The present invention has the advantage of reducing the maximum instantaneous lighting requirement by a factor of five. This allows fewer and lower brightness LED's to be used which reduces cost. It also allows a shorter duration strobe pulse to be used which reduces motion blur to yield a better image. It also filters out some of the noise in the measured position of the registration marks introduced by random artifacts on the substrate that can have the same spectral response as the printed marks.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of the calibration system of a multi-printhead printing system of the present invention;

FIG. 2 is a side view of an image capture device of the present invention used in FIG. 1;

FIG. 3 is a bottom view of FIG. 2; and

FIG. 4 is a diagram illustrating test patterns printed along the print media with strobe and exposure timing pulses to capture images of the test patterns according to the invention.

### DETAILED DESCRIPTION OF THE INVENTION

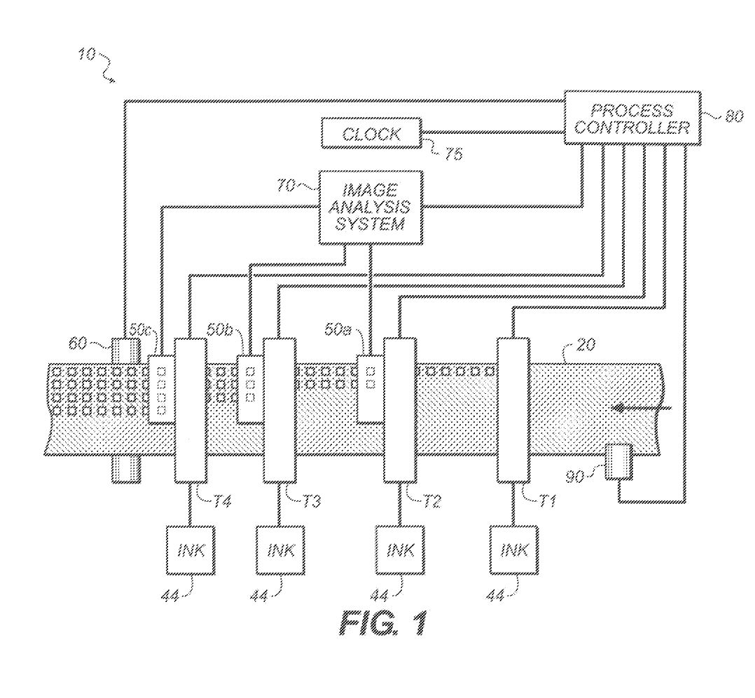

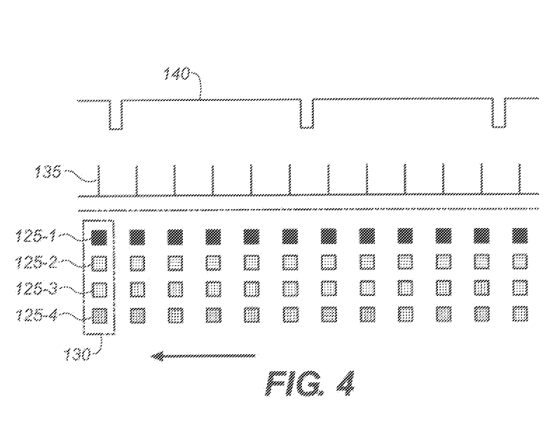

Turning now to FIG. 1, there is shown a block diagram of the printing system 10 of the present invention. The printing system 10 includes a transport for transporting the print media 20 through various stages of the printing process. Four printheads (T1, T2, T3 and T4) span over the print media 20 each for dispensing ink of a different color on the print media 20 as the media 20 moves relative to the printheads T1-T4. In the preferred embodiment, each printhead T1-T4 prints a series of test marks so that, after printing by the last printhead T4, a series of four test mark test patterns are printed as shown in FIG. 4. Referring back to FIG. 1, four ink holding receptacles 44, each of a different color, are respectively attached to each printhead T1-T4 for supplying ink thereto. Three image capture devices 50a, 50b and 50c are respectively disposed immediately downstream and in close proximity of each of the last three printhead T2-T4 but not the first printhead T1. Each image capture device 50a, 50b and 50c includes a digital camera and a light source. Typically the light sources are strobe lights for producing a plurality of short bright flashes of light to allow an image to be captured without motion blur. Typically the strobe lights consist of a plurality of Light Emitting Diodes (LEDs), commonly of red, green and blue LEDs that are the color compliments of cyan, magenta, and yellow inks, respectively, that are printed by the printheads. By using LEDs that are the color complement of the color inks, image contrast is enhanced. For example, a yellow mark on the print media will appear as a high contrast dark mark when illuminated only with a blue LED. Black ink which absorbs all colors shows up in high contrast with any visible light LED so a separate LED is not needed for the black ink. Each image capture device 50a-50c captures an image of the media 20 after the printhead T2-T4 prints its respective ink on the media 20 for providing feedback as to whether calibration of the printing system is needed and, if so, the degree of calibration to be preformed, as described in commonly-assigned and co-pending U.S. patent application Ser. No. ______ (D-94958). A drive motor (not shown) connected to a drive roller 60 exerts force on the print media for moving it through the printing system 10.

The printing system 10 includes various components that perform process control and analysis. In this regard, an image system analyzer 70 receives the images captured by the image capture devices 50a-50c respectively located downstream of each printhead T2-T4 to determine whether the ink marks printed by the respective printheads T1-T4 are aligned relative to each other as expected if aligned properly. In general, the image system analyzer 70 converts the images into bit maps, identifies each of the test marks, and determines their locations within the image, and calculates their alignment relative to each other in both the x and y directions, if any. Based on the result, the image system analyzer 70 sends a signal to the process controller 80. The printing system also includes a clock 75 that creates a clock pulse train. The clock 75 communicates with the process controller 80, which uses the clock pulse train to create a frequency-shifted pulse train for each of the printheads T2, T3, and T4. It is noted that, in a four ink system, three images are captured with the initial ink mark not being imaged alone as there is no relative relationship by which the initial mark may be analyzed for correctness.

An encoder 90 is used to monitor the motion (in the direction of the arrow) of the print media 20 through the printing system 10. Typically the encoder 90 is in the form of a rotary encoder that creates a defined number of pulses per revolution. The rotary encoder is connected to a roller or wheel (not shown) that is rotated by the moving paper. The circumference of the wheel or roller, in combination with the defined number of pulses per revolution of the rotary encoder 90, determines the number of encoder pulses per centimeter or inch of paper travel. The output of the encoder 90, in the form of an encoder pulse train is used by the process controller 80 for controlling the placement of the print media 20 along the direction of print media travel. Typically the spacing of pixels in the in-track direction (along the direction of paper motion) corresponds to N times the spacing between encoder pulses, where N is a small (<10) integer. To properly print a multi-color document, the print data sent to each printhead T2-T4 downstream of the first printhead T1 must be delayed by increasing amounts relative to the data of the first printhead. These delays are normally defined in terms of a delay count or the number of the encoder pulses that correspond to the spacing along the paper path of the printheads T2-T4 from the first printhead T1. For example, if the second printhead T2 is located 8.5 inches downstream of the first printhead T1 and the encoder 90 produces 600 pulses per inch, the print data to the second printhead T2 would be delayed by 5100 pulses relative to the data to the first printhead T1.

The print media 20 passes under and in the optical path of the digital camera 100 in order to capture the printed test marks from the printheads T1-T4. Various digital cameras 100 can be employed provided they have sufficient optical resolution and light sensitivity to capture images of the test marks. One such useful camera is the IMP-VGA210-L from Imperx. This is a black and white camera with a 640×480 pixel resolution. It is able to output images at a rate of 210 complete frames per second through a CameraLink™ interface to an image processing system. This camera also has an external trigger and an externally controllable electronic shutter so that acquisition of images and the shutter time for acquiring an image can be controlled by the process controller 80. This camera also allows a portion of the active pixels in the captured image frame to be defined as an area of interest. The camera sensor then uses only that portion of its active pixels for image capture, and only transfers the image data corresponding to that area of interest to the image system analyzer 70. By so doing, the camera is able to capture and transfer partial frame images at higher frame rates than its complete frame rate. An infinite conjugate micro-video lens from Edmund Optics, #56776, with a 25 mm focal length and a 1:1 magnification is an effective lens for use with this camera. In one embodiment, the strobe lights 110 are light emitting diodes, two LED's each of red, green and blue, arranged circular around the lens of the camera. Light emitting diodes from Luxeon, such as LXHL-PH09, LXHL-PM09, and LXHL-PRO09, are examples of usable LED's. The image capture device may be mounted on a carriage downstream of each printhead so that the image capture device is adjustable in position in a cross-track direction. Alternatively, the image capture device may be mounted directly to downstream side of the printhead so that it can capture the image of the test marks printed by that printhead and the first printhead.

During the printing process however, it is possible for the effective spacing between the printheads T1-T4 to vary, due, for instance, to stretching of the print media 20, resulting in misregistration of the images from the various printheads T1-T4. If by means of the image capture device and the image processing unit such a registration error is detected, the process controller 80 can modify the operation of the printing system 10 to correct for this misregistration as described in commonly-assigned and co-pending U.S. patent application Ser. No. ______ (D-94958).

It is noted that, while the description above describes the printer in terms of four printheads each printing a separate color, the invention is not limited to printing systems having exactly four printheads.

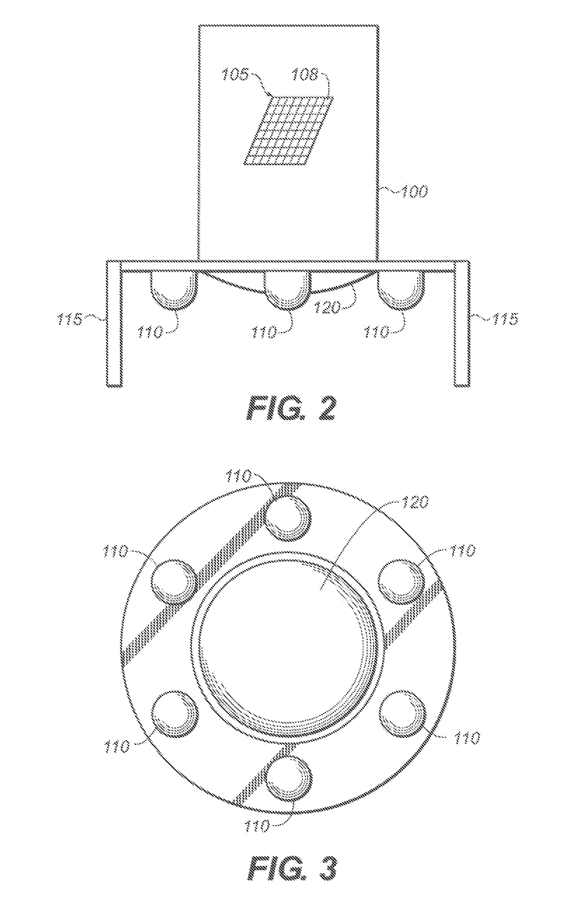

Referring to FIGS. 2 and 3, there is shown an exemplary image capture device 50a-50c of the present invention. The image capture device 50a-50c includes a digital camera 100 having a plurality of strobe lights 110. A lens 120 is disposed in the optical path of the digital camera 100 for providing optical focus for the digital camera 100. An image sensor 105 is disposed in the camera 100 for converting incident light into charge packets, as is well known in the art. According to design preference, the image sensor 105 may use only a portion of its pixels 108 for image capture (i.e., charge collection) as described hereinabove. For illustration purposes, the image sensor 105 is oriented so as to illustrate the pixels 108, but in actual practice, the pixels 108 are physically oriented so as to capture the incident light passed through the lens 120. Optionally, the image capture device 50a-50c includes a light shield 115 for shielding the camera 100 from ambient light.

Referring to FIG. 4, there is shown the media having the test marks 125-1 through 125-4 printed thereon by the printheads T1-T4, respectively. A set of test marks from the various printheads whose intended positions on the print media have a defined relationship form a test pattern. In this example, the test pattern 130 consists of the test marks 125-1 through 125-4 within the phantom box. The test marks in this pattern have a defined spacing relative to each other. While the test marks in this example test pattern 130 are evenly spaced along a line, other spatial relationships between the test marks are also possible. In this illustration, it is noted that the test pattern consists of marks from each printhead T1-T4; however, the present invention is also applicable when the test pattern consists of test marks from at least two printheads. These test patterns are regularly spaced along the direction of print media motion, denoted by the arrow. In one preferred embodiment, the test patterns are spaced apart from each other by a fixed distance that is within the range of 0.040 to 0.15 inches

As the print media moves through the printing system, the test patterns that are regularly spaced along the print media move in succession through the field of view of an image capture device 50 at uniform time intervals. Based on the output from the encoder 90, the process controller 80 creates strobe firing pulses 135 to synchronize the flash of the strobe lights 110 with the motion of the test pattern 130. In this manner, each test pattern is illuminated by a single strobe-light flash when they are each at substantially the same location within the field of view of the camera.

The process controller also creates camera capture pulses 140 that controls the shutter time interval over which the digital camera 100 acquires an image. As shown, the time duration of the camera capture pulse 140 is long compared to a strobe pulse, allowing a plurality of strobe pulses, five strobe pulses in this embodiment, to occur during a single image capture. As the amount of ambient light reflected from the print media while it is in the field of view of the digital camera is small compared to the amount of strobe light reflected from the print media, the acquired image is essentially a superposition of five strobed test pattern images. Capturing an image with such a superposition of strobed images, enables the acceptable images to be acquired while reducing significantly the illumination intensity requirements of the strobe. This allows fewer and lower brightness LEDs to be used, which reduces cost. It also allows a shorter duration strobe pulse to be used which reduces motion blur to yield a better image.

The superposition of multiple strobe images to form a single captured image also serves to produce an exposure averaged image from multiple test patterns. This is beneficial as it averages away image artifacts that may be associated with a single test pattern. It is known that there can be some variation in the appearance of individual test patterns. These can be produced, for example, by wicking of ink along individual fibers in the print media, by variations in the uniformity of various print media coatings, or by the presence of ink splash droplets around the printed test marks. This exposure averaging process by combining multiple test pattern images into a single captured image makes the measurement of test mark location less sensitive to the presence of print artifacts associated with a single test mark.

While FIG. 4 illustrated the use of five strobe flashes within the time interval during which a single image is captured, other numbers of strobe flashes may be employed. In one embodiment, number of strobe flashes within the time interval during which a single image is captured depends on speed of the print media through the multi-color printing system. In another embodiment, the number of strobe flashes within the time interval depends on either or both brightness and contrast of a previously captured image. For example, if the previously captured image had low brightness and therefore low contrast, the process controller causes the number of strobe pulses to be increased to improve the brightness of acquired images.

In another embodiment, the contrast of the captured test pattern images is enhanced by using different number of strobe flashes for the various LEDs 110 that surround the digital camera 100. By way of example, the red LED may be flashed fewer times than the green or blue LEDs during the shutter time of the camera to acquiring a single image. Such a variation in the number of strobe flashes for the various LEDs may be desirable based on differences in the brightness of the different color LEDs, differences in the absorption of the inks at the wavelengths of the LEDs, or the color of the print media. As the registration of the image plane printed by each printhead T2-T4 is made relative to the image plane printed by printhead T1, the image capture device associated with a printhead only needs to capture high contrast images of the test mark printed by the associated printhead and the test mark printhead by printhead T1. For example, if T1 prints cyan ink and T4 prints yellow ink, image capture device 50c should yield high contrast images of the cyan and yellow test marks. As red is the color complement of cyan and blue the color complement of yellow, the red and blue LEDs of image capture device 50c are flashed more times than the green LED during the capture of a single image by the camera.

Preferably, each test pattern is spaced apart from each other at substantially a range of 0.040 to 0.15 inches and a frame rate of the camera 100 is substantially between a range of 100 to 300 frames per second. This enables the printing system to capture multiple images within a single document, and color registration corrections to be made multiple times within a document.

The invention has been described in detail with particular reference to certain preferred embodiments thereof, but it will be understood that variations and modifications can be effected within the spirit and scope of the invention.

### PARTS LIST

T1-T4 printheads
10 printing system
20 print media
44 holding receptacles
50a-50c image capture devices
60 drive roller
70 image system analyzer
75 clock
80 process controller
90 encoder
100 digital camera
105 image sensor
108 pixels
110 strobe light
115 light shield
120 lens
125 test marks
130 test pattern
135 strobe firing pulse
140 camera capture pulse

1. A method for capturing an image in a multi-color printing system, the method comprising the steps of:
(a) providing a test pattern on a print media having a plurality of test patterns aligned in a first direction in a repeating pattern;
(b) providing an image capture device having a shutter that controls a time interval during which a single image is captured;
(c) flashing a strobe light multiple times within the time interval in which a single image is captured; wherein each strobe light flash is synchronized with motion of the test pattern past the image capture device so that each test pattern is illuminated by a single strobe-light flash at substantially the same location within the captured image.

2. The method as in claim 1, wherein the synchronization includes an encoder that measures displacement of the print media through the multi-color printing system.

3. The method as in claim 1, wherein the number of strobe flashes within the time interval during which a single image is captured depends on speed of the print media through the multi-color printing system.

4. The method as in claim 1 further comprising the step of shielding the image capture device from ambient light.

5. The method as in claim 1, wherein the number of strobe flashes within the time interval depends on either or both brightness and contrast of a previously captured image.

6. The method as in claim 1, wherein the strobe light is a light emitting diode strobe light.

7. The method as in claim 6, wherein the light emitting diode strobe light is a plurality of light emitting diodes of different colors.

8. The method as in claim 7, wherein one or more of the light emitting diodes can be flashed a different number of times from the other light emitting diodes during the single image capture.

9. The method as in claim 1, wherein the image capture is used for registration of image planes of the multi-color printing system.

10. The method as in claim 1, wherein the image capture is used for a color control system of the multi-color printing system.

11. The method as in claim 1, wherein the test patterns are spaced apart at substantially a range of 0.040 to 0.15 inches and a frame rate of the image capture device is substantially between a range of 100 to 300 frames per second.

12. The method as in claim 11, wherein the image capture device includes a sensor that uses only a portion of its active pixels for image capture.

13. The method as in claim 1, wherein a single image is captured multiple times within the same document.
